(19) United States
(12) Patent Application Publication
(10) Pub. No.: US 2013/0111372 A1
(43) Pub. Date: May 2, 2013

(54) PREFERENCE MANAGEMENT METHODS AND APPARATUS

(71) Applicant: Sten Herlitz, Boston, MA (US)

(72) Inventor: Sten Herlitz, Boston, MA (US)

(73) Assignee: General Electric Company, Schenectady, NY (US)

(21) Appl. No.: 13/285,577

(22) Filed: Oct. 31, 2011

(51) Int. Cl. G06F 3/048

(52) U.S. Cl. 715/762

(57) ABSTRACT

Preference management methods and apparatus are disclosed. An example apparatus includes receiving a request for a preference setting from a first application; obtaining a first context value via a context manager in response to the request; and using the first context value to obtain the requested preference setting.

### FIELD OF THE DISCLOSURE

The present disclosure relates generally to healthcare information systems and, more particularly, to preference management methods and apparatus.

### BACKGROUND

Healthcare environments, such as hospitals and clinics, typically include information systems (e.g., electronic medical record (EMR) systems, lab information systems, outpatient and inpatient systems, hospital information systems (HIS), radiology information systems (RIS), storage systems, picture archiving and communication systems (PACS), etc.) to manage healthcare information such as, for example, patient medical histories, imaging data, test results, diagnosis information, management information, financial information, and/or scheduling information. The information may be centrally stored or divided at a plurality of locations. Healthcare practitioners may desire to access patient information or other information at various points in a healthcare workflow. For example, during surgery, medical personnel may access patient information, such as images of a patient's anatomy, which are stored in a medical information system. Further, healthcare practitioners may enter new information, such as medical history, diagnostic, financial, or treatment information into a healthcare information system before and/or after a completed medical procedure, analysis, and/or appointment. Healthcare practitioners often utilize a plurality of applications on a computing platform (e.g., a workstation) to interact with a plurality of information sources across the healthcare information system.

### SUMMARY

An example method includes receiving a request for a preference setting from a first application; obtaining a first context value associated with the first application via a context manager in response to the request; using the first context value to obtain the requested preference setting; and providing the requested preference setting to the first application.

An example context manager includes a receiver to receive a first request from an application for a preference setting; a retriever to obtain a first context value associated with the first application; and an interface to obtain the requested preference setting using the first context value and to provide the requested preference setting to the application.

An example preference manager includes a memory to store preference settings in connection with one or more context values; a receiver to receive a request including a first context value obtained via a context manager; a retriever to query the memory using the first context value; and a communicator to provide one or more of the preference settings corresponding to the first context value to a device associated with the request.

### BRIEF DESCRIPTION OF THE DRAWINGS

FIG. 1 is a block diagram of an example healthcare information system utilizing the examples disclosed herein.

FIG. 2 is a block diagram of an example apparatus that may be used to implement the example context manager of FIG. 1.

FIG. 3 is a block diagram of an example apparatus that may be used to implement the example preference manager of FIG. 1.

FIG. 4 is a flow diagram representative of example machine readable instructions that may be executed to implement the example context manager of FIGS. 1 and/or 2.

FIG. 5 is a flow diagram representative of example machine readable instructions that may be executed to implement the example preference manager of FIGS. 1 and/or 3.

FIG. 6 is a block diagram of an example processor system that may be used to execute the machine readable instructions of FIG. 4 to implement the example context manager of FIGS. 1 and/or 2 and/or to execute the machine readable instructions of FIG. 5 to implement the example preference manager of FIGS. 1 and/or 3.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

Given a set of circumstances, parameters, scenarios, settings, etc., a user may prefer a computing device, an application, a program, etc., to behave in a certain fashion. That is, users may make one or more preferences known to a device or system such that the device or system responds with those preference(s) when certain events or circumstances occur. Many computing platforms involve some type of preference management to facilitate the implementation of the preferences during execution of a program and/or application and/or to enable the user to make his or her preferences known to the platform. Such a preference management system can manage user preferences ranging from a simple case of system-wide preferences to entity-specific preferences (e.g., preferences based on location, role, user level, etc.) or compound breakout preferences in which preference settings depend on multiple session-specific context values or on other parameters (e.g., time of day and/or time zone). Generally, the preference management system stores one or more preferences in connection with one or more context values. In addition to the user preferences, the preference management system may also manage one or more configuration settings corresponding to one or more devices or systems. The configuration settings may also be associated with one or more context values or other parameters. Thus, given one or more context values at a computing platform requesting preference information, the preference management system implements and/or returns the one or more preference settings (e.g., user preferences and/or configuration settings) corresponding to the context values.

In previous systems, the platform requesting the preference setting information must pass current context values to the preference management system along with the request for the preference setting information. Having to gather and communicate all relevant context information to retrieve a preference setting is burdensome. For example, the platforms of previous systems were required to continuously, or at least repeatedly, be aware of context values necessary to retrieve one or more desired preference settings. Further, to set preferences and/or configurations given a certain type of context, the platform of previous systems was required to support that type of context. In other words, if a platform did not support a certain context (e.g., a user location or user role), then preference settings could not be set based on that type of context in previous systems.

The examples disclosed herein provide a preference management system that utilizes knowledge of a context management system to enhance an ability of a platform to implement one or more preference settings. Healthcare information systems sometimes employ a context management system, such as a Clinical Context Object Workgroup (CCOW) system. While the following description includes examples utilizing CCOW data, the example methods, apparatus, systems, and/or articles of manufacture disclosed herein can be implemented in connection with any suitable type of context data (e.g., in combination with CCOW data and/or in isolation). Typically, context data is maintained by context management systems to enable synchronization across disparate applications or programs executed on a healthcare information device (e.g., a medical workstation at a hospital or clinic) being used by a healthcare practitioner (e.g., a physician, a physician's assistant, a nurse, a support staff member, administrative personnel, a member of a billing department, etc.). The CCOW standard, for example, uses a technique referred to as “context management” to provide a unified view of information associated with separate and/or different healthcare applications related to a subject (e.g., a patient, a user, a practitioner, and/or a healthcare event (e.g., an appointment, test, analysis, trauma, procedure, etc.), a location, etc.). In such instances, when a practitioner enters subject identifying data (e.g., a patient identifier or a user identifier) into a first application (e.g., an admissions program) of a CCOW-enabled system to cause a presentation of information related to the patient in the first application, a second application (e.g., a financial program) of the CCOW-enabled system automatically retrieves its respective information related to the patient and displays the same to the user of the system. That is, context management systems enable efficient cross-application workflows by automatically synchronizing common context subjects (e.g., Patient or User). As a result, the user is spared the trouble of having to log in multiple times and to look up the same subject (e.g., patient) in each application.

By using the knowledge of the context management system (e.g., a CCOW system), the examples disclosed herein enable platforms requesting or requiring preference setting information to issue a request to retrieve the desired preference settings without having to pass context information along with the request for the preference setting information. For example, the examples disclosed herein enable a platform to execute a function call not having any context value parameters (e.g., GetPreference( )as opposed to Get Preference(user role, time)) to retrieve user preference information. Consequently, the examples disclosed herein also enable platforms to avoid having to continuously, or at least repeatedly, track context values. Instead, the platforms can rely on the context management system to provide the context values needed to lookup one or more preference settings). Additionally, the examples disclosed herein enable a first platform or application to base one or more preference settings on context values that are not supported by the first platform/application. The basis for such a preference may be provided, via the context management system, by a second platform/application that supports those context values and provides the same to the context management system. Thus, the examples disclosed herein enable platforms implementing preference settings to, for example, more efficiently operate (e.g., without having to track one or more context values necessary for user preferences), to more efficiently retrieve preference setting information (e.g., with a function call not including context value parameters), to base preferences on context value(s) beyond the capabilities of the platform, and to otherwise implement user preferences in improved fashion.

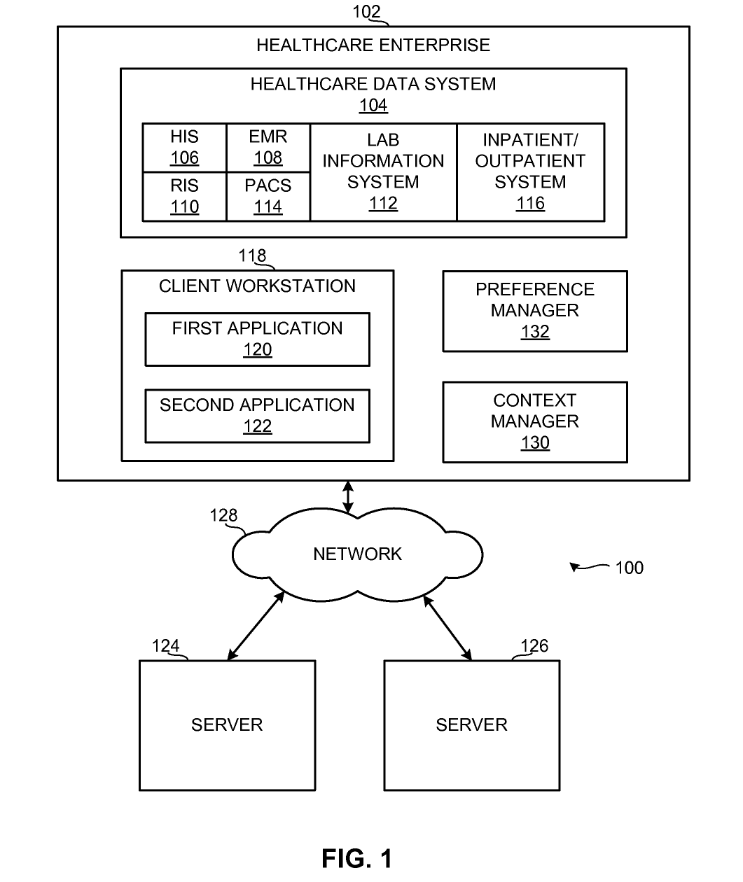

FIG. 1 is a block diagram of an example healthcare information system 100 in which the examples disclosed herein may be implemented. The example healthcare information system 100 of FIG. 1 includes a healthcare enterprise 102. The healthcare enterprise 102 may be any type of healthcare facility such as, for example, a clinic, a physician's office, a laboratory, a testing center, etc. The example healthcare information system 100 of FIG. 1 may include additional or alternative healthcare enterprises that are configured to share healthcare information. For example, the example healthcare information system 100 of FIG. 1 may implement an XDS (Cross Enterprise Document Sharing) integration profile to facilitate the sharing (e.g., registration, distribution, access, etc.) of healthcare data among the healthcare enterprises (which are collectively referred to as an Affinity Domain in IHE (Integrating the Healthcare Enterprise) XDS terminology).

In the illustrated example of FIG. 1, the enterprise 102 includes a healthcare data system 104. Generally, the healthcare data system 110 of FIG. 1 includes one or more information systems and/or components configured to store, manipulate, analyze, and/or otherwise process healthcare information. The example healthcare data system 104 of FIG. 1 includes a hospital information system (HIS) 106, an electronic medical record (EMR) system 108, a radiology information system (RIS) 110, a lab information system 112, a picture archiving and communication system (PACS) 114, and an inpatient/outpatient system 116. In some examples, the healthcare data system 104 also includes a broker (e.g., a Mitra Imaging's PACS Broker) to allow medical information and medical images to be transmitted together and stored together. In the illustrated example, the HIS 106, the EMR system 108, the RIS 110, the lab information system 112, the PACS 114, and the inpatient/outpatient system 116 are housed in the hospital 102 and locally archived. However, in other implementations, the HIS 106, the EMR system 108, the RIS 110, the lab information system 112, the PACS 114, and/or the inpatient/outpatient system 116 may be housed one or more other suitable locations. Furthermore, one or more components of the healthcare data system 104 may be combined and/or implemented together. For example, the RIS 110 and/or the PACS 114 may be integrated with the HIS 106; the PACS 114 may be integrated with the RIS 110; and/or each of the example information components 106-116 may be integrated together. Preferably, information (e.g., test results, observations, diagnosis, discharges, admissions, etc.) is entered into the information component(s) 106-116 by healthcare practitioners (e.g., radiologists, physicians, technicians, administrators, etc.) before, after, and/or during a patient examination and/or testing session. The HIS 106, the EMR system 108, the RIS 110, the lab information system 112, the PACS 114, and the inpatient/outpatient system 116 may be in communication via, for example, a Wide Area Network (WAN) such as a private network or the Internet. More generally, any of the coupling(s) described herein may be via a network. In such instances, the network may be implemented by, for example, the Internet, an intranet, a virtual private network, a wired or wireless Local Area Network, and/or a wired or wireless Wide Area Network.

The workstation 118 may be any equipment (e.g., a personal computer) capable of executing software that permits electronic data (e.g., medical reports) and/or electronic medical images (e.g., x-rays, ultrasounds, MRI scans, medical reports, test results, etc.) to be acquired, stored, or transmitted for viewing and operation. The workstation 118 receives commands and/or other input from a user (e.g., a physician, surgeon, nurse, or any other healthcare practitioner) via, for example, a keyboard, mouse, track ball, microphone, etc. The example workstation 118 include first and second applications 120 and 122 that facilitate interactions and exchanges with, for example, the healthcare data system 104 and/or any other suitable source of data and/or processing capabilities. In addition to the applications 120 and 120 local to the workstation 118, the workstation 118 utilizes resources implemented on one or more servers 124 and 126 located remotely from the workstation 118 via, for example, a network 128, such as a LAN and/or the Internet. In some examples, the workstation 118 can access one or both of the servers 124 and 126 using an alternative network (e.g., without traversing the network 128).

The example healthcare enterprise 102 of FIG. 1 also includes a context manager 130 and a preference manager 132 that interacts with the context manager 130 to provide user preference services to, for example, a user of the workstation 118. In the illustrated example of FIG. 1, the context manager 130 is a context manager in a Clinical Context Object Workgroup (CCOW) system. However, the example preference manager 130 and/or the workstation 108 may be utilized in connection with any type of context data system (e.g., in combination with CCOW data and/or in isolation). Generally, the context manager 130 and additional aspects or components of the CCOW system in which the context manager 130 is implemented track and store context information associated with the healthcare enterprise 102 and/or other healthcare enterprises. In particular, the context manager 130 of FIG. 1 tracks and stores context values associated with, for example, the first and second applications 120 and 122 implemented in connection with the workstation 108. Example context values include location, user role, user level, application status, displayed information, user status, patient identifier, modality, physician identifier, etc. As described above, while the first application 120 may support a first set of context values, the second application 122 may support a second set of context values different from the first set. Additionally, in certain instances, the first application 120 may provide certain context values supported by both the first application 120 and the second application 122 to the context manager 130, while the second application 122 provides other context values to the context manager 130. In other words, any number of combinations of the first and second applications 120 and 122, and/or other applications associated with the context manager 130 may provide context values that can be tracked and stored by the context manager 130.

In the illustrated example, a software development kit (SDK) embedded on the applications 120, 122 of the workstation 118 provides an application programming interface (API) that enables the applications 120, 122 of the workstation 118 to interact with the context manager 130. The API that has been configured and/or modified in accordance with the examples disclosed herein. In particular, the example API is provided with one or more function calls (e.g., GetPreference( ) that the workstation 118 can use to call the context manager 130 for obtaining preference setting information. The function call provided by the examples disclosed herein enables the workstation 118 to utilize the context values tracked by the context manager 130 when determining which user preference should be implemented. That is, the workstation 118 can rely on the context values tracked by the context manager 130 to provide the user preference services to the user of the workstation 118.

The context manager 130 receives the request (e.g., function call) from the workstation 118 for preference setting information and provides context value(s) to the request. Further, in the illustrated example in which the context manager 130 is implemented locally with the workstation 118, the context manager 130 can gather local context values that also may be useful and/or necessary to obtain the requested preference setting information. For example, in addition to system-wide context values, the locally implemented context manager 130 of FIG. 1 may also gather local context values such as, for example, a device identifier (e.g., a computer name), screen resolution, time, time zone, etc. In some examples, the context manager 130 is implemented remotely on, for example, one of the servers 124 and 126, in which case logic to gather local context value(s) could be provided by the SDK embedded in the applications 120, 122. In some examples, the applications 120, 122 could additionally or alternatively explicitly pass in context value(s) using internal information.

Having the context value(s), the request can be forwarded to the preference manager 132. The example preference manager 132 stores preference settings in connection with the context value(s) that causes the corresponding preference(s) to be implemented. Thus, given a certain context value or set of context values, the preference manager 130 returns one or more preference settings that should be used on the workstation 118 due to the received context value(s) being present on the workstation 118.

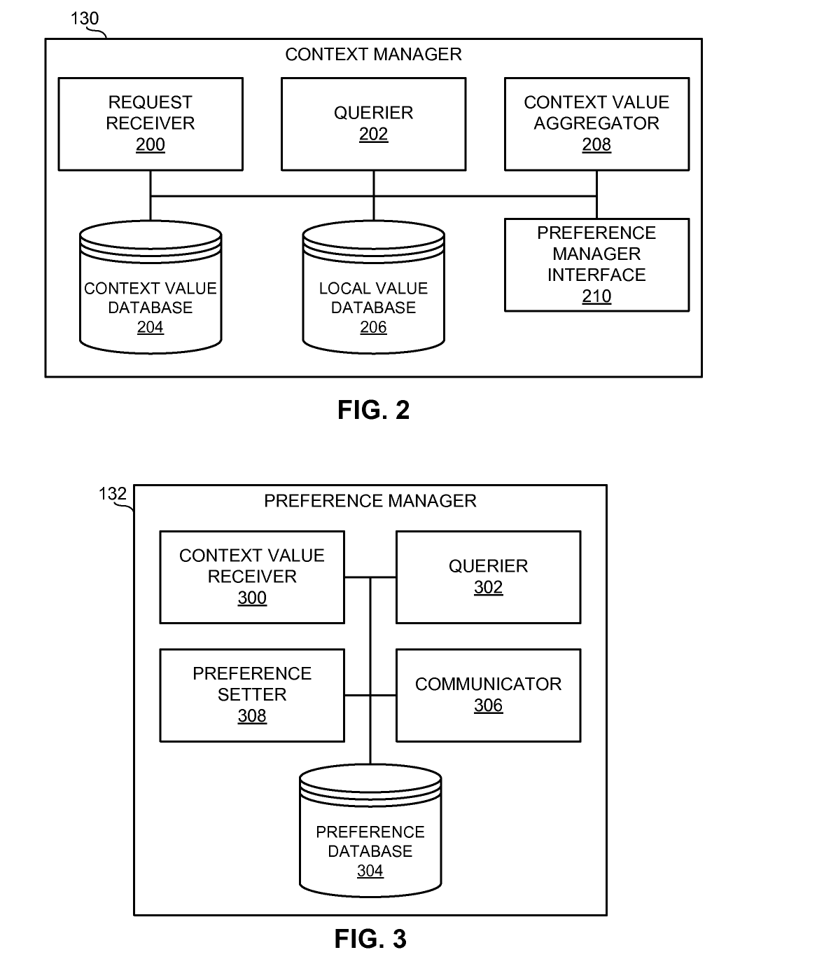

FIG. 2 is a block diagram of an example apparatus that may be used to implement the example context manager 130 of FIG. 1. In the illustrated example of FIG. 3, the example context manager 130 includes a request receiver 200, a querier 202, a context value database 204, a local value database 206, a context value aggregator 208, and a preference manager interface 210. While an example manner of implementing the context manager 130 of FIG. 1 has been illustrated in FIG. 2, one or more of the elements, processes and/or devices illustrated in FIG. 2 may be combined, divided, re-arranged, omitted, eliminated and/or implemented in any other way. Further, the example request receiver 200, the example querier 202, the example context value aggregator 208, the example preference manager interface 210, and/or, more generally, the example context manager 130 of FIG. 2 may be implemented by hardware, software, firmware and/or any combination of hardware, software and/or firmware. Thus, for example, any of the example request receiver 200, the example querier 202, the example context value aggregator 208, the example preference manager interface 210, and/or, more generally, the example context manager 130 of FIG. 2 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus or system claims are read to cover a purely software and/or firmware implementation, at least one of the example request receiver 200, the example querier 202, the example context value aggregator 208, the example preference manager interface 210, and/or, more generally, the example context manager 130 of FIG. 2 may be implemented by hardware, software, firmware and/or any combination of hardware, software and/or firmware. Thus, for example, any of the example request receiver 200, the example querier 202, the example context value aggregator 208, the example preference manager interface 210, and/or, more generally, the example context manager 130 of FIG. 2 are hereby expressly defined to include a tangible and/or non-transitory computer readable medium such as a physical memory, DVD, CD, etc. storing the software and/or firmware. Further still, the example context manager 130 of FIG. 2 may include one or more elements, processes and/or devices in addition to, or instead of, those illustrated in FIG. 2, and/or may include more than one of any or all of the illustrated elements, processes and devices.

The example request receiver 200 of FIG. 2 receives requests for preference setting information from, for example, the workstation 118 of FIG. 1. The request receiver 200 may be configured to receive requests from the first and/or second application 120, 122 that utilizes an API configured and/or modified to generate requests interpretable by the request receiver 200. For example, the request receiver 200 may be configured to requests in the form of function calls from the application(s) 120 and/or 122. As described above, the examples disclosed herein enable such a function call to be passed to the request receiver 200 without any context value parameters. Instead, the application calling the context manager 130 can rely on the context manager 130 to provide the context values necessary to determine an applicable preference setting. The example request receiver 200 extracts and records address or identification information associated with the received request and provides the request to the querier 202.

The example querier 202 determines an identification of a user and/or device that originated the request using, for example, the address and/or identification information extracted from the request. The querier 202 uses the identification information to query the context value database 204. The example context value database 204 returns current context values associated with the requesting user and/or device or platform. As described above, the context value database 204 is aware of current context values by way of the context management services provided by, for example, CCOW components and capabilities. The example querier 202 also queries the local value database 206 to obtain local context values, if any, applicable to the received request. For example, the local value database 206 may provide a screen resolution of a local device associated with the request, such as a monitor related to the workstation 118.

The context value aggregator 208 aggregates the context values provided by the context value database 204 and the local context values provided by the local value database 206 (if any). That is, the context value aggregator 208 packages the different types of context values into a request to be conveyed to the preference manager 132 of FIG. 1. To convey such a request, the example context manager 130 includes the preference manager interface 210. The example preference manager interface 210 may be programmed with, for example, an address of the preference manager 132 and is configured to establish, for example, a communication session with the preference manager 132. The request and the corresponding context values generated by the aggregator 208 are conveyed to the preference manager interface 210. In response, the preference manager interface 210 expects to receive one or more user preference settings that can be conveyed back to the requesting platform, such as the workstation 118.

In some examples, the request receiver 200 receives a request from, for example, the workstation 118 to set one or more preference settings associated with a user. In such instances, the user of the workstation 118 may desire to alter, establish, customize, and/or otherwise interact with a collection of preference settings stored in association with the user. In response to receiving such a request, the example request receiver 200 can provide the request directly to the preference manager interface 210, which can then forward the request to the preference manager 132. As described below, the example preference manager 132 can alter the collection of preference settings in accordance with the user request.

FIG. 3 is a block diagram of an example apparatus that may be used to implement the example preference manager 132 of FIG. 1. In the illustrated example of FIG. 3, the example preference manager 132 includes a context value receiver 300, a querier 302, a preference database 304, a communicator 306, and a preference setter 308. While an example manner of implementing the preference manager 132 of FIG. 1 has been illustrated in FIG. 3, one or more of the elements, processes and/or devices illustrated in FIG. 3 may be combined, divided, re-arranged, omitted, eliminated and/or implemented in any other way. Further, the example context value receiver 300, the example querier 302, the example communicator 306, the example preference setter 308, and/or, more generally, the example preference manager 132 of FIG. 3 may be implemented by hardware, software, firmware and/or any combination of hardware, software and/or firmware. Thus, for example, any of the example context value receiver 300, the example querier 302, the example communicator 306, the example preference setter 308, and/or, more generally, the example preference manager 132 of FIG. 3 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus or system claims are read to cover a purely software and/or firmware implementation, at least one of the example context value receiver 300, the example querier 302, the example communicator 306, the example preference setter 308, and/or, more generally, the example preference manager 132 of FIG. 3 may be implemented by hardware, software, firmware and/or any combination of hardware, software and/or firmware. Thus, for example, any of the example context value receiver 300, the example querier 302, the example communicator 306, the example preference setter 308, and/or, more generally, the example preference manager 132 of FIG. 3 are hereby expressly defined to include a tangible and/or non-transitory computer readable medium such as a physical memory, DVD, CD, etc. storing the software and/or firmware. Further still, the example preference manager 132 of FIG. 3 may include one or more elements, processes and/or devices in addition to, or instead of, those illustrated in FIG. 3, and/or may include more than one of any or all of the illustrated elements, processes and devices.

The example context value receiver 300 of FIG. 3 receives the context values obtained via the context manager 130 in response to the request received from the workstation 118. The context values received at the context value receiver 300 can include context values from the context value database 204 and/or the local value database 206 as aggregated by the aggregator 208. The example context value receiver 300 of FIG. 3 also receives and/or extracts identification information associated with the request to identify which user, device, platform, application, etc. originated the request. For example, the contex value receiver 300 may identify the first application 120 as the requestor preference setting information, the second application 122 as the requestor of preference setting information, the workstation 118 as the requestor of preference setting information, a user of the workstation 118 (e.g., according to login data and/or any other technique in which a user may be identified, such as a facial recognition system implemented in connection with the workstation 118), and/or any combination of these and other identities associated with a request.

Using the one or more identities associated with the request and the received context value(s), the example querier 302 queries the preference database 304. In the illustrated example, the preference database 304 includes a plurality of entries in which preference settings are linked or otherwise associated with one or more identities and/or combinations of identities (e.g., a first user at a first workstation, a first user using a first application, etc.). In some examples, the preference settings stored in the preference database 304 also include one or more rules and/or conditions by which the corresponding preference settings are to be implemented. In other words, the preference settings and/or one or more aspects of the preference settings may be implemented conditionally based on the rule(s). The example preference database 304 uses the identities(s) associated with the request and the context value(s) to return one or more preference settings (and/or any accompanying rules) that the identified entities have selected to occur given the received context value(s). In the illustrated example, the preference database 304 provides any preference setting(s) to the communicator 306 for conveyance to, for example, the context manager 130. In some examples, the communicator 306 may provide the preference setting(s) directly to the identified requesting device.

Having the user preference information provided by the preference manager 132 via the context manager 130, the requesting device (e.g., the workstation 118, the first application 120 and/or the second application 122) can implement the user preference setting(s) accordingly. Thus, the requesting device is able to implement a plurality of user preferences without having to track or even support each context value on which the user preferences are based. Such a system provides a highly flexible, centralized preference management system or scheme that can be expanded and utilized efficiently by a large amount of devices and/or applications.

As described above in connection with FIG. 3, the context manager 130 may receive a request from, for example, the workstation 118 to set or alter one or more preference settings related to, for example, the first application 120, the second application 122 and/or a user of the workstation 118. In such instances, the context manager 130 provides the request to the preference setter 308. The example preference setter 308 has access to the preference database 304 and permission to alter the contents thereof. In some examples, set-permissions vary based on, for example, a user-role or user-rights and/or the preference breakout parameters. That is, certain preference settings are available to a certain user for modification and/or setting, while other users are not allowed to modify the preference settings. In some examples, one or more authentications are required by the preference setter 308 and/or the preference database 304 before content of the preference database 304 can be altered. In some examples, the preference setter 308 may receive a request to set and/or modify a preference setting of the preference database 304 directly from, for example, the workstation 118. Further, the preference setter 308 may send an acknowledgement indicative of the request being successfully processed to the requesting device or entity.

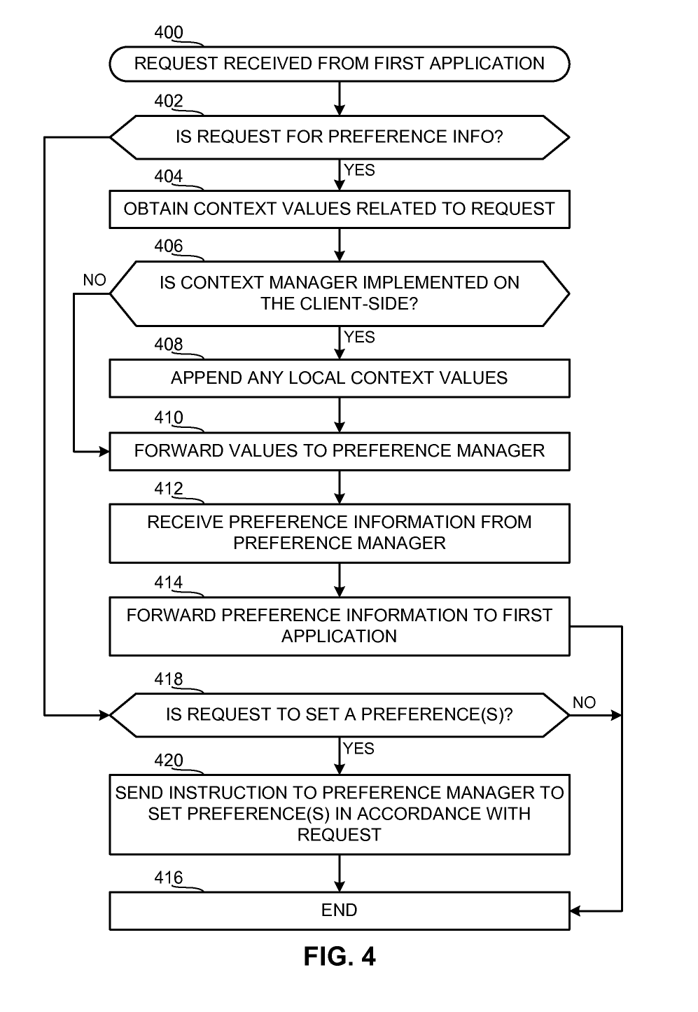

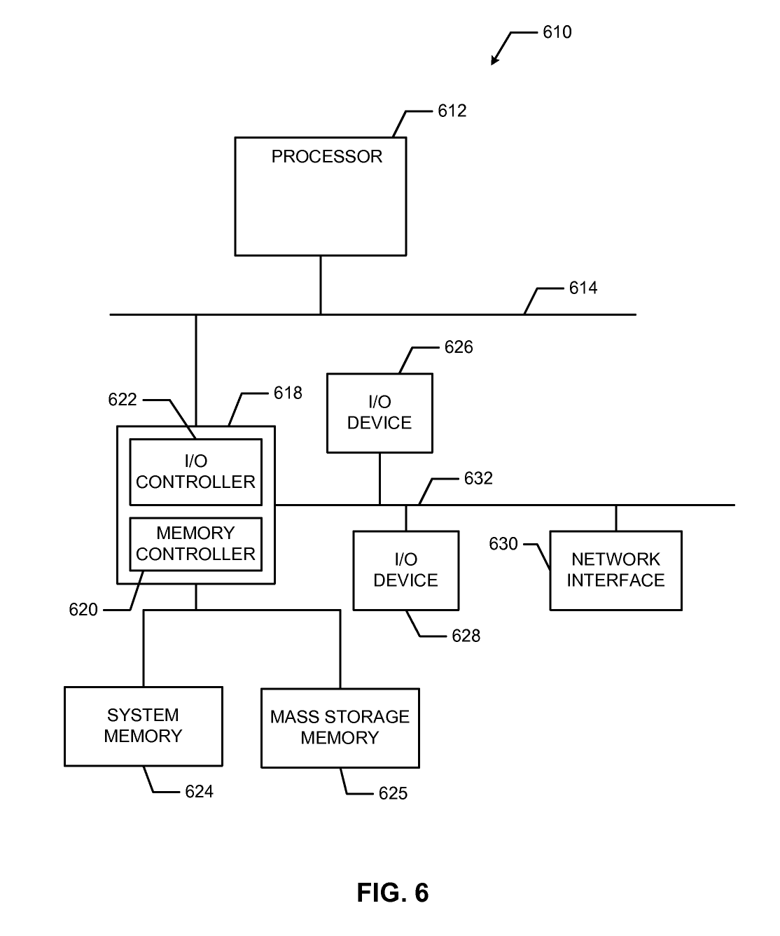

FIG. 4 is a flow diagram representative of example machine readable instructions that may be executed to implement the example context manager 130 of FIGS. 1 and/or 2. In the example of FIG. 4, the machine readable instructions comprise programs and/or routines for execution by a processor such as the processor 612 shown in the example processor platform 610 discussed below in connection with FIG. 6. The programs may be embodied in software stored on a computer readable medium such as a CD-ROM, a floppy disk, a hard drive, a digital versatile disk (DVD), and/or any form of physical memory associated with the processor 612, but the entire program and/or parts thereof could alternatively be executed by a device other than the processor 612 and/or embodied in firmware or dedicated hardware. Further, although the example programs are described with reference to the flowcharts illustrated in FIG. 4, many other methods of implementing the example context manager 130 may alternatively be used. For example, the order of execution of the blocks may be changed, and/or some of the blocks described may be changed, eliminated, or combined.

As mentioned above, the example processes of FIG. 4 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIG. 4 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

FIG. 4 begins with a request being received at the request receiver 200 of the context manager 130 (block 400). The request may be from, for example, the first application 120 of the workstation 118 of FIG. 1 executing a function call. The example request receiver 200 extracts address or identification information associated with the request (e.g., an identity of the device and/or program/application originating the request). The request receiver 200 determines if the request is a request for preference setting information such as, for example, a GetPreference( )call (block 402). If so, the example querier 202 uses the extracted identification information to query the context value database 204 to obtain context value(s) related to the request (block 404). If the context manager 130 is implemented locally with the requesting device (e.g., the workstation 118 of FIG. 1) (block 406), the example querier 202 also queries the local value database 206 to obtain local context values (e.g., a screen resolution of display of the workstation 118), if any, applicable to the received request. The aggregator 208 aggregates the context values from the context value database 204 and the local values from the local value database 206 by, for example, appending the local values from the local value database 206 to the context values from the context value database 204 (block 408).

The preference manager interface 210 then provides the context values (e.g., aggregated values) to the preference manager 132 in conjunction with any information associated with the request related to an identity of the requesting device and/or user (block 410). The preference manager 132 uses the context values to obtain one or more preference settings desired by the requesting device and/or user when the context(s) of the context values are present in the requesting device. The context manager 130 receives the preference setting information in response to the context values provided to the preference manager 132 by the preference manager interface 210. The received user preference information can then be forwarded to the requesting device (block 414). The example of FIG. 4 then ends (block 416).

Referring back to block 402, when the request receiver 200 determines that the request is not for preference setting information, control passes to block 418. At block 418, the request receiver 200 determines whether the request is a request to set one or more preference settings. If not, the example of FIG. 4 ends (block 416). Otherwise, the preference manager interface 210 sends the request to the preference manager 132 (block 420). As described below, the example preference manager 132 can alter the collection of preference settings in accordance with the user request. The example of FIG. 4 then ends (block 416).

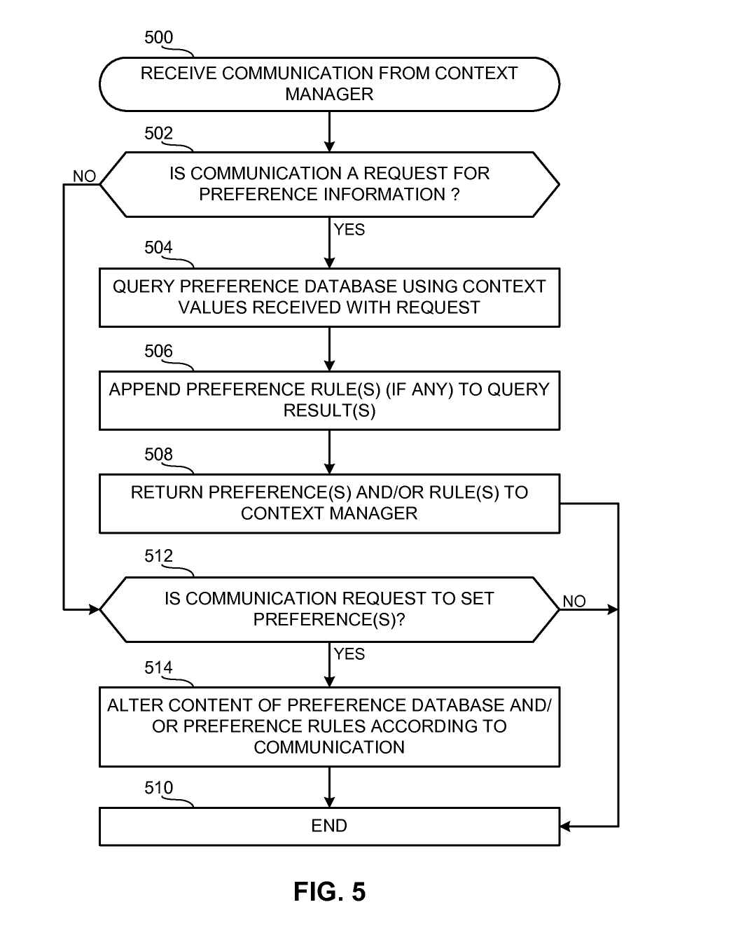

FIG. 5 is a flow diagram representative of example machine readable instructions that may be executed to implement the example preference manager 132 of FIGS. 1 and/or 3. In the example of FIG. 5, the machine readable instructions comprise programs and/or routines for execution by a processor such as the processor 612 shown in the example processor platform 610 discussed below in connection with FIG. 6. The programs may be embodied in software stored on a computer readable medium such as a CD-ROM, a floppy disk, a hard drive, a digital versatile disk (DVD), and/or any form of physical memory associated with the processor 612, but the entire program and/or parts thereof could alternatively be executed by a device other than the processor 612 and/or embodied in firmware or dedicated hardware. Further, although the example programs are described with reference to the flowcharts illustrated in FIG. 5, many other methods of implementing the example preference manager 132 may alternatively be used. For example, the order of execution of the blocks may be changed, and/or some of the blocks described may be changed, eliminated, or combined.

As mentioned above, the example processes of FIG. 5 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIG. 5 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

FIG. 5 begins with the preference manager 132 receiving a communication from the context manager 130 of FIGS. 1 and/or 2 (block 500). The preference manager 132 determines if the communication is a request for user preference setting information (block 502). If not, control proceeds to block 512, which is described below. If the communication is a request for preference setting information (block 502), the context value receiver 300 extracts the context value(s) received with the communication and the querier 302 queries the preference database 304 using the context value(s) (block 504). As described above, the preference database 304 includes preference settings stored in connection with certain context values in accordance with the desired preferences of the corresponding users. In some examples, the preference database 304 also stores one or more rules and/or conditions associated with the preference settings. In such instances, the preference database processes the rules/conditions or appends them to the query results (block 506). The communicator 306 then returns the preference setting(s) and/or rule(s) to the context manager 130 (block 508). The example of FIG. 5 then ends (block 510).

Referring back to block 502, if the communication received at the preference manager 132 is not a request for preference setting information, the preference manager 132 determines if the communication is a request to set one or more preference settings (block 512). If not, the example of FIG. 5 ends (block 510). If the communication is a request to set preference setting(s) (block 512), the example preference setter 308 sets or alters the content of the preference database and/or the corresponding rule(s) in accordance with the received communication (block 514). The example of FIG. 5 then ends (block 510).

FIG. 6 is a block diagram of an example processor system 610 that may be used to implement the apparatus and methods disclosed herein. As shown in FIG. 6, the processor system 610 includes a processor 612 that is coupled to an interconnection bus 614. The processor 612 may be any suitable processor, processing unit or microprocessor. Although not shown in FIG. 6, the system 610 may be a multi-processor system and, thus, may include one or more additional processors that are identical or similar to the processor 612 and that are communicatively coupled to the interconnection bus 614.

The processor 612 of FIG. 6 is coupled to a chipset 618, which includes a memory controller 620 and an input/output (I/O) controller 622. As is well known, a chipset typically provides I/O and memory management functions as well as a plurality of general purpose and/or special purpose registers, timers, etc. that are accessible or used by one or more processors coupled to the chipset 618. The memory controller 620 performs functions that enable the processor 612 (or processors if there are multiple processors) to access a system memory 624 and a mass storage memory 625.

The system memory 624 may include any desired type of volatile and/or non-volatile memory such as, for example, static random access memory (SRAM), dynamic random access memory (DRAM), flash memory, read-only memory (ROM), etc. The mass storage memory 625 may include any desired type of mass storage device including hard disk drives, optical drives, tape storage devices, etc.

The I/O controller 622 performs functions that enable the processor 612 to communicate with peripheral input/output (I/O) devices 626 and 628 and a network interface 630 via an I/O bus 632. The I/O devices 626 and 628 may be any desired type of I/O device such as, for example, a keyboard, a video display or monitor, a mouse, etc. The network interface 630 may be, for example, an Ethernet device, an asynchronous transfer mode (ATM) device, an 802.11 device, a DSL modem, a cable modem, a cellular modem, etc. that enables the processor system 610 to communicate with another processor system.

While the memory controller 620 and the I/O controller 622 are depicted in FIG. 6 as separate blocks within the chipset 618, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method, comprising:
receiving a request for a preference setting from a first application;
obtaining, via a processor, a first context value via a context manager in response to the request;
using, via the processor, the first context value to obtain the requested preference setting; and
providing the requested preference setting to the first application.

2. A method as defined in claim 1, wherein providing the requested preference setting comprises conveying the obtained preference setting to a device associated with the request.

3. A method as defined in claim 1, further comprising obtaining a second context value local to a device implementing the first application.

4. A method as defined in claim 3, further comprising aggregating the second context value with the first context value and using the aggregation to obtain the requested preference setting.

5. A method as defined in claim 1, wherein the first context value is a value of a context associated with the first application at a time at which the request is received.

6. A method as defined in claim 1, wherein the first context value is set by a second application different from the first application.

7. A method as defined in claim 1, further comprising receiving a second request to alter one or more preference settings and altering, via the context manager, the one or more preference settings in accordance with the second request.

8. A method as defined in claim 1, wherein the context manager is a Clinical Context Object Workgroup (CCOW) manager that manages the context values for the first application.

9. A context manager, comprising:
a receiver to receive a first request from an application for a preference setting;
a retriever to obtain a first context value; and
an interface to obtain the requested preference setting using the first context value and to provide the requested preference setting to the application.

10. A context manager as defined in claim 9, wherein the interface is to provide the requested preference setting by conveying the obtained preference setting to a device associated with the request.

11. A context manager as defined in claim 9, wherein the retriever is to obtain a second context value local to a device implementing the first application.

12. A context manager as defined in claim 11, further comprising an aggregator to aggregate the first and second context values, wherein the aggregation is to be used to obtain the requested preference setting.

13. A context manager as defined in claim 9, wherein the first context value is a value of a context associated with the first application at a time at which the request is received.

14. A context manager as defined in claim 9, wherein the first context value is set by a second application different from the first application.

15. A context manager as defined in claim 9, wherein the receiver is to receive a second request to alter one or more preference settings, and further comprising a setter to alter the one or more preference settings in accordance with the second request.

16. A context manager as defined in claim 9, wherein the context manager is a Clinical Context Object Workgroup (CCOW) manager that manages the context values for the first application.

17. A preference manager, comprising:
a memory to store preference settings in connection with one or more context values;
a receiver to receive a request including a first context value obtained via a context manager;
a retriever to query the memory using the first context value; and
a communicator to provide one or more of the preference settings corresponding to the first context value to a device associated with the request.

18. A preference manager as defined in claim 17, further comprising a setter to alter the one or more preference settings in accordance with a second request.

19. A preference manager as defined in claim 17, wherein the context manager from which the first context value is obtained is to managed context values for a first application from which the request originated.

20. A preference manager as defined in claim 19, wherein the preference setting comprises a setting associated with the first application.
